(19) United States
(12) Patent Application Publication
(10) Pub. No.: US 2026/0248592 A1
(43) Pub. Date: Aug. 27, 2026

(54) ORTHODONTIC APPLIANCE FOR PROTRACTION OF UPPER FRONT TEETH TO ACHIEVE FACIAL BALANCE

(71) Applicant: Soonthorn PRATNIWAT, Khon Kaen (TH)

(72) Inventor: Soonthorn PRATNIWAT, Khon Kaen (TH)

(21) Appl. No.: 18/995,181

(22) PCT Filed: Mar. 30, 2024
(86) PCT No.: PCT/TH2024/050016

§ 371 Date: Jan. 16, 2025

(30) Foreign Application Priority Data
Mar. 31, 2023 (TH) 2303000940

(51) Int. Cl. A61C 7/08

(52) U.S. Cl. CPC A61C 7/08

(57) ABSTRACT

The orthodontic appliance for protraction of upper front teeth to achieve facial balance comprising the first appliance (1) that comprises the upper plate (5) located at the back of six upper front teeth and firmly secured with an orthodontic adhesive, with the first hook (3) and the second hook (4) attached to the upper plate (5) of the first appliance, and the second appliance (2) that comprises the right plate (6) and the left plate (7) covering all the upper posterior teeth, with the first wire (8) attached to the right plate (6) and the left plate (7), and with the second wire (9) that is a stainless steel spring hard wire at the premolars made into the left U-Loop (12) and the right U-Loop (13) while both ends of the wire are attached to the right plate (6) and the left plate (7).

### FIELD OF THE INVENTION

This invention is related to an appliance used in dentofacial orthopedics, which is a part of orthodontic science. In particular, this invention is related to bone ossification or bone modeling, which will help improve the results of orthodontic treatment.

### BACKGROUND OF THE INVENTION

In the past, maxillary expanders were a special appliance for the treatment of dental and maxillary bones abnormalities in patients with mandibular prognathism and maxillary hypoplasia. The appliance was used to pull the maxillary bones and teeth forward to properly align the upper teeth with the lower front teeth and improve the angle. The current appliance for the treatment of maxillary bones abnormalities is called a protraction headgear or a facemask.

FIG. 1 and FIG. 2 illustrate the popular prior inventions, i.e. Dr. DeLaire's protraction headgear and Dr. Petit's facemask, respectively. These appliances work the same way by pulling the bones and teeth forward. Each appliance comprises two components, including an intraoral acrylic plate fixed with all the upper teeth, which consists of two hooks attached to tooth number 16 and 26, and an extraoral tool with pressure supports on the chin and the forehead that are connected by a curved metal piece with a horizontal metal strip or a hard plastic piece to strengthen the module.

The prior appliances are large and difficult to wear. It requires multiple steps to put on and take off, and it can be easily dislodged during sleep. Additionally, the appliances could be unappealing and noticeable, making it uncomfortable for the user to speak and to wear them in public. Consequently, these limitations can hinder the performance of daily activities and potentially contribute to protracted treatment durations.

### SUMMARY OF THE INVENTION

The objective of the present invention is to make an intraoral orthodontic appliance for the purpose of enhancing maxillary expansion, and to make a smaller, lighter, easy-to-wear, and less-visible appliance that is more effective and reduce treatment time without causing any discomfort to the oral region.

The orthodontic appliance for protraction of upper front teeth to achieve facial balance comprises two main appliances attached to the patient's teeth. The first appliance (1) comprises an upper plate (5) located at the back of six upper front teeth and firmly secured with an orthodontic adhesive, with a first hook (3) and a second hook (4) made of a stainless steel spring hard wire adhered at both ends of the upper plate (5).

The second appliance (2) comprises a right plate (6) and a left plate (7) that cover the rest of the posterior teeth and partially cover the palate, with a first wire (8) that is a stainless steel spring hard wire attached to the right plate (6) and the left plate (7) and with a second wire (9) that is a stainless steel spring hard wire curved along the front teeth. At the central front teeth area, a third hook (10) and a fourth hook (11) are provided. The second wire (9) at the premolar area made into a left U-Loop (12) and a right U-Loop (13) while both ends of the wire are attached to the right plate (6) and the left plate (7).

### BRIEF DESCRIPTION OF DRAWINGS

FIG. 1 illustrates Dr. Delaire's extraoral tool.

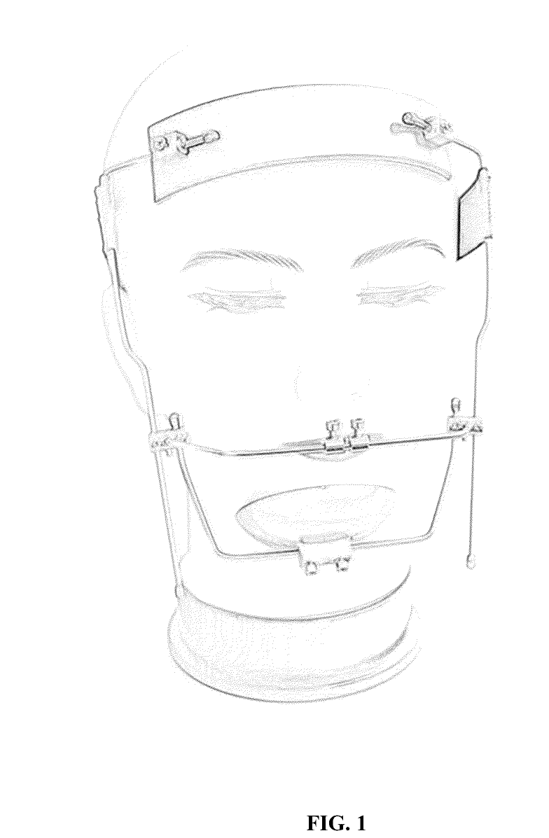

FIG. 2 illustrates Dr. Petit's extraoral tool.

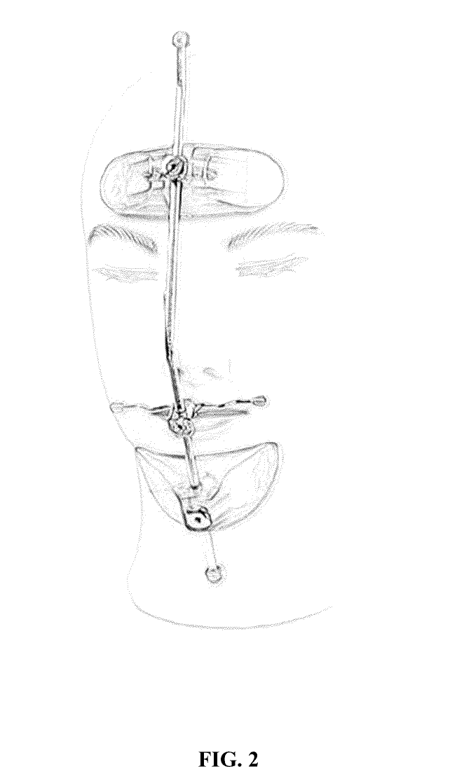

FIG. 3 illustrates the overall components of the orthodontic appliance for protraction of upper front teeth to achieve facial balance according to the present invention.

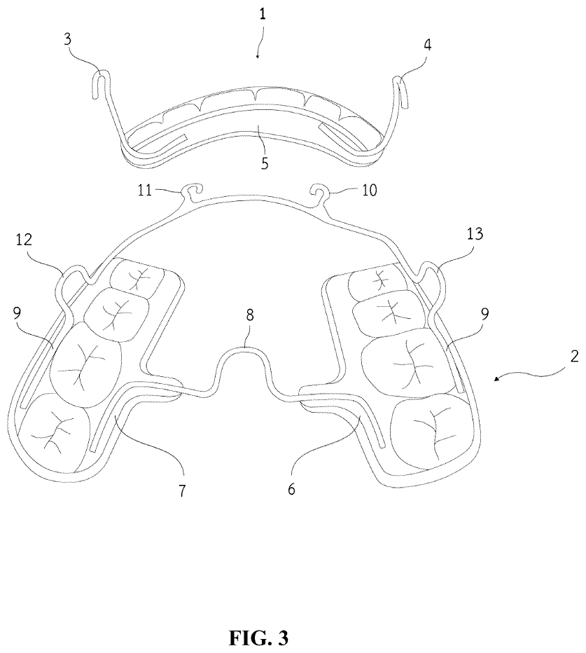

FIG. 4 illustrates the first appliance (1) that is fixed to upper front teeth.

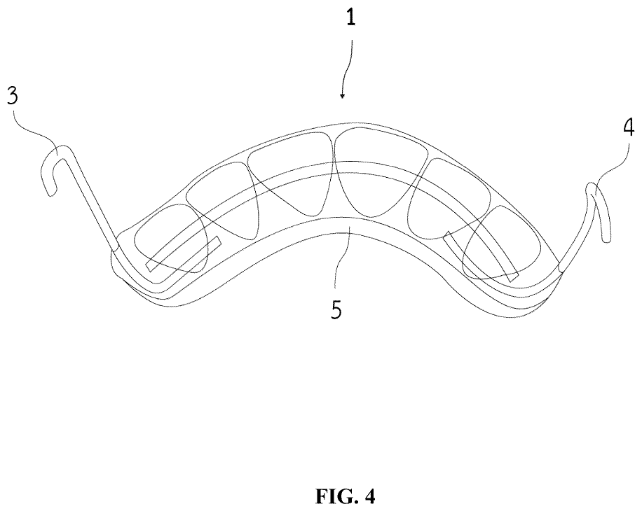

FIG. 5 illustrates the second appliance (2) that is a removable piece.

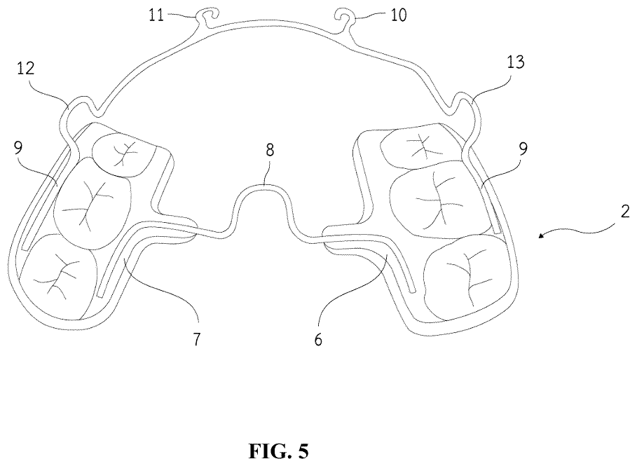

FIG. 6 illustrates the location of the first appliance (1) and the second appliance (2) on a dental plaster model.

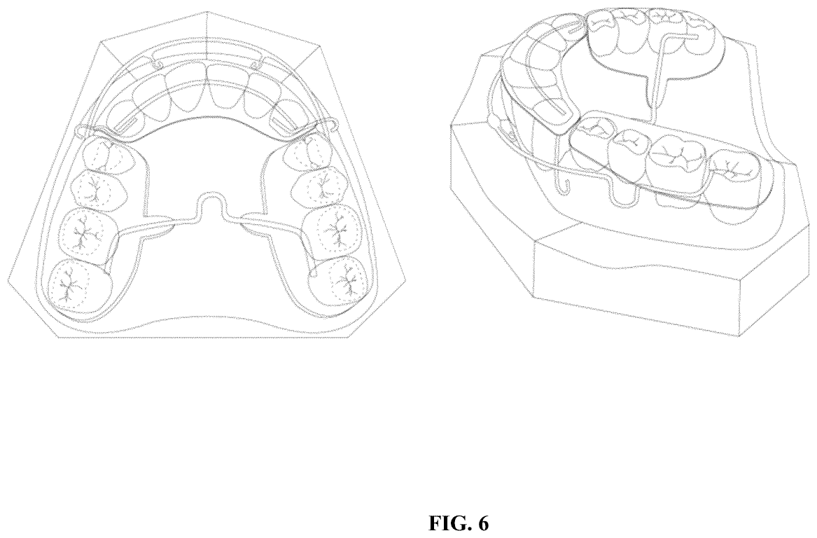

FIG. 7 illustrates various configuration of the first wire (8) of the second appliance (2).

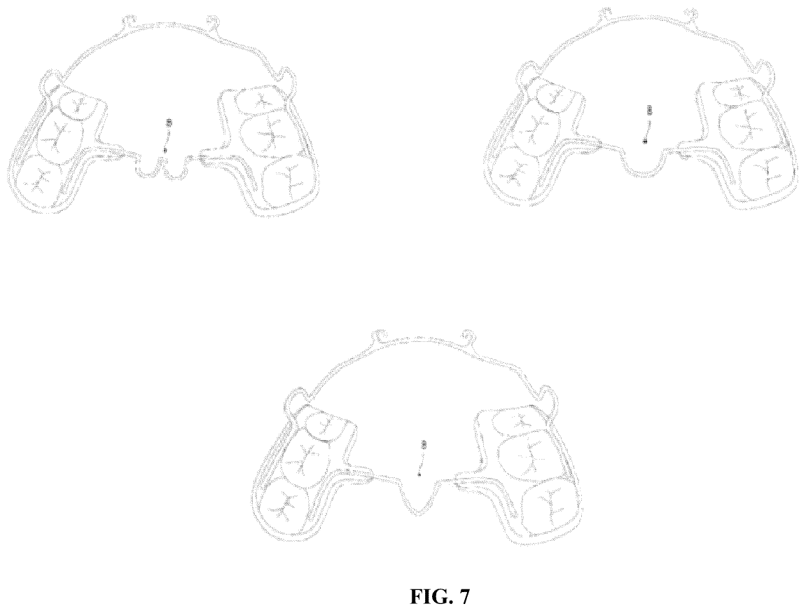

### DETAILED DESCRIPTION OF THE INVENTION

An orthodontic appliance for protraction of upper front teeth to achieve facial balance according to the present invention comprises two main appliances: the first appliance (1) and the second appliance (2). The first appliance (1) comprises the upper plate (5) located at the back of six upper front teeth and firmly secured with an orthodontic adhesive, with the first hook (3) and the second hook (4) attached to the upper plate (5).

The first hook (3) and the second hook (4) have the diameter of 0.5-1.2 millimeters and have the height of 10-17 millimeters. Each of them is attached to the upper plate.

The second appliance (2) comprises the right plate (6) and the left plate (7) located at both sides of the palate and covered all the posterior teeth. On the lingual side, the right plate (6) and the left plate (7) are aligned to the palate, each with 10-15 millimeters away from the center of the palate, with the first wire (8) that is a stainless steel spring hard wire with the diameter of 0.6-1.3 millimeters attached to the right plate (6) and the left plate (7).

The second wire (9) that is a stainless steel spring hard wire with the diameter of 0.6-1.3 millimeters is curved along the upper front teeth. The front part of the wire is formed into the third hook (10) and the fourth hook (11). The second wire (9) that is curved along the premolars is made into the left U-Loop (12) and the right U-Loop (13) with the width and height of 3-10 millimeters while both ends of the wire are attached to the right plate (6) and the left plate (7).

The third hook (10) and the fourth hook (11) preferably have the height of 4-12 millimeters. Both ends face each other. Both hooks are 10-17 millimeters away from each other.

The upper plate (5), the right plate (6), and the left plate (7) can be selected from an acrylic plate or a transparent plastic plate.

The function of the orthodontic appliance for protraction of upper front teeth to achieve facial balance according to the present invention starts from fitting the first appliance (1) with the upper front teeth with an orthodontic adhesive. Then, fitting the second appliance (2) by placing the second wire (9) at the upper front teeth before placing the right plate (6) and the left plate (7), whichever is easier. Bring ⅛ inch elastics of 3.5 ounce or ⅜ inch elastics of 3.5 ounce to pull the first hook (3) to the fourth hook (11) and pull the second hook (4) to the third hook (10) for 8 to 20 hours. Replace the elastics when the tension decreases.

### BEST MODE OF THE INVENTION

As described in Detailed Description of the Invention.

What is claimed is:

1. An orthodontic appliance for protraction of upper front teeth to achieve facial balance, comprising the first appliance (1) and the second appliance (2),
characterized in that
the first appliance (1) comprises the upper plate (5) located at the back of six upper front teeth and firmly secured with an orthodontic adhesive, with the first hook (3) and the second hook (4) attached on the upper plate (5);
the second appliance (2) comprises the right plate (6) and the left plate (7) located at both sides of the palate and covered all the posterior teeth, while, on the lingual side, the plates are aligned to the palate, away from the center, with the first wire (8) that is a stainless steel spring hard wire attached to the right plate (6) and the left plate (7);
the second wire (9) that is a stainless steel spring hard wire with the diameter of 0.6-1.3 millimeters is curved along the upper front teeth, wherein the front part of the wire is formed into the third hook (10) and the fourth hook (11) and wherein the second wire (9) that is curved along the premolars is made into the left U-Loop (12) and the right U-Loop (13) while both ends of the wire are attached to the right plate (6) and the left plate (7).

2. The orthodontic appliance for protraction of upper front teeth to achieve facial balance according to claim 1, wherein the first hook (3) and the second hook (4) have the diameter of 0.5-1.2 millimeters and have the height of 10-17 millimeters, while each of them is attached to the upper plate.

3. The orthodontic appliance for protraction of upper front teeth to achieve facial balance according to claim 1, wherein the upper plate (5) is curved along the upper front teeth.

4. The orthodontic appliance for protraction of upper front teeth to achieve facial balance according to claim 1, wherein each of the right plate (6) and the left plate (7) attached to the palate are 10-15 millimeters away from the center of the palate.

5. The orthodontic appliance for protraction of upper front teeth to achieve facial balance according to claim 1, wherein the upper plate (5), the right plate (6), and the left plate (7) can be selected from an acrylic plate or a transparent plastic plate.

6. The orthodontic appliance for protraction of upper front teeth to achieve facial balance according to claim 1, wherein the first wire (8) is a stainless steel spring hard wire with the diameter of 0.6-1.3 millimeters.

7. The orthodontic appliance for protraction of upper front teeth to achieve facial balance according to claim 1, wherein the third hook (10) and the fourth hook preferably (11) have the height of 5-7 millimeters, wherein the second hook ends face each other and are 10-17 millimeters away from each other.

8. The orthodontic appliance for protraction of upper front teeth to achieve facial balance according to claim 1, wherein the wire (9) at the premolars has the width and height of 3-10 millimeters, while both ends of the wire are attached to the right plate (6) and the left plate (7).
